(19) United States
(12) Patent Application Publication
(10) Pub. No.: US 2026/0182555 A1
(43) Pub. Date: Jul. 2, 2026

(54) FISHING LURE AND METHOD OF MANUFACTURE

(71) Applicant: Oliver Mowat, Commerce, TX (US)

(72) Inventor: Oliver Mowat, Commerce, TX (US)

(21) Appl. No.: 19/301,668

(22) Filed: Aug. 15, 2025

Related U.S. Application Data
(60) Provisional application No. 63/683,691, filed on Aug. 15, 2024.

(51) Int. Cl. A01K 85/00

(52) U.S. Cl. CPC A01K 85/1897; A01K 85/1811; A01K 85/1837; A01K 85/1851

(57) ABSTRACT

A modified fishing lure (100) for attracting and capturing fish. The fishing lure comprises a flexible body (102) having a rigid hook (104) and weight (500) disposed therein. A cutting tool (200) is used to create an aperture through the side of the lure (100) for appropriate placement of the weight (500).

### FIELD OF THE INVENTION

The present disclosure is directed generally to fishing lures and in particular to the method of making a fishing lure having enhanced effectiveness in attracting fish.

### SUMMARY OF THE INVENTION

The present disclosure is directed to a lure for attracting and catching fish. The lure comprises a flexible body in the shape of a small fish having a rigid steel hook and a weight disposed therein.

### BRIEF DESCRIPTION OF THE DRAWING FIGURES

The foregoing disclosure will be best understood, and the advantages thereof made most clearly apparent, when consideration is given to the following detailed description in combination with the drawing figures presented. The detailed description makes reference to the following drawings:

FIG. 1A is a first side view of a fishing lure according to the present disclosure;

FIG. 1B is a bottom view of the fishing lure of FIG. 1A;

FIG. 1C is a second side view of the fishing lure of Figures A1 and 1B;

FIG. 1D is a top view of the fishing lure of FIGS. 1A-1C;

FIG. 2A is a top view of a cutting tool according to the present disclosure;

FIG. 2B is a front end view of the cutting tool of FIG. 2A;

FIG. 2C is a side view of the cutting tool of FIGS. 2A and 2B;

FIG. 2D is a back end view of the cutting tool of FIGS. 2A-2C;

FIG. 2E is a bottom view of the cutting tool of FIGS. 2A-2D;

FIG. 3A is a top view of the first stage of a cutting operation according to the present disclosure;

FIG. 3B is a side view of the first stage of the cutting operation shown in FIG. 3A;

FIG. 4A is a top view of a second stage of the cutting operation shown in FIGS. 3A and 3B;

FIG. 4B is a side view of the second stage of the cutting operation shown in FIGS. 3A, 3B and 4A;

FIG. 4C is a top view of the third stage of the cutting operation shown in FIGS. 3A, 3B, 4A and 4B;

FIG. 5A is a top view of a weight insertion operation;

FIG. 5B is a side view of a fishing lure having a weight inserted therein; and

FIG. 5C is a top view of the fishing lure shown in FIG. 5B.

### DETAILED DESCRIPTION OF THE INVENTION

The following detailed description provides certain specific embodiments of the subject matter disclosed herein. Although each embodiment represents a single combination of elements, the subject matter disclosed herein should be understood to include sub-combinations of the disclosed elements. Thus, if one embodiment comprises elements A, B, and C, and a second embodiment comprises elements B and D, then the inventive subject matter is also intended to include other remaining combinations of A, B, C, or D, even if not explicitly disclosed herein.

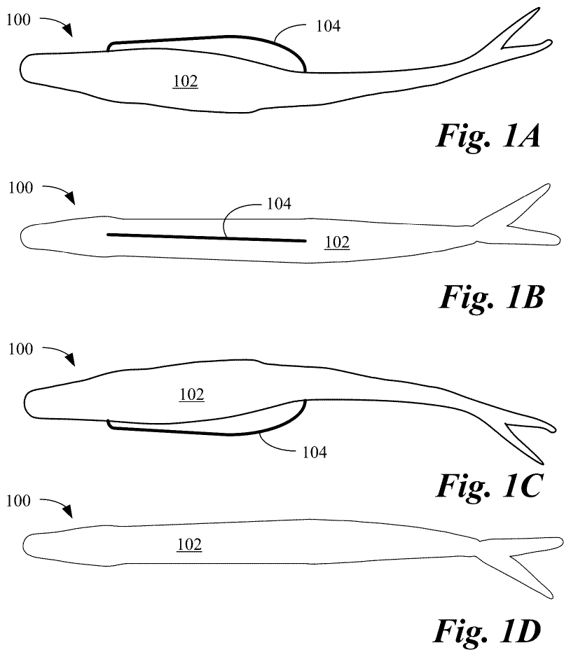

FIG. 1A is a first side view of a fishing lure 100 according to the present disclosure. FIG. 1B is a bottom view of fishing lure 100. FIG. 1C is a second side view of fishing lure 100. FIG. 1D is a top view of fishing lure 100. Fishing lure 100 generally comprises a flexible body 102 having a rigid steel hook 104 disposed therein.

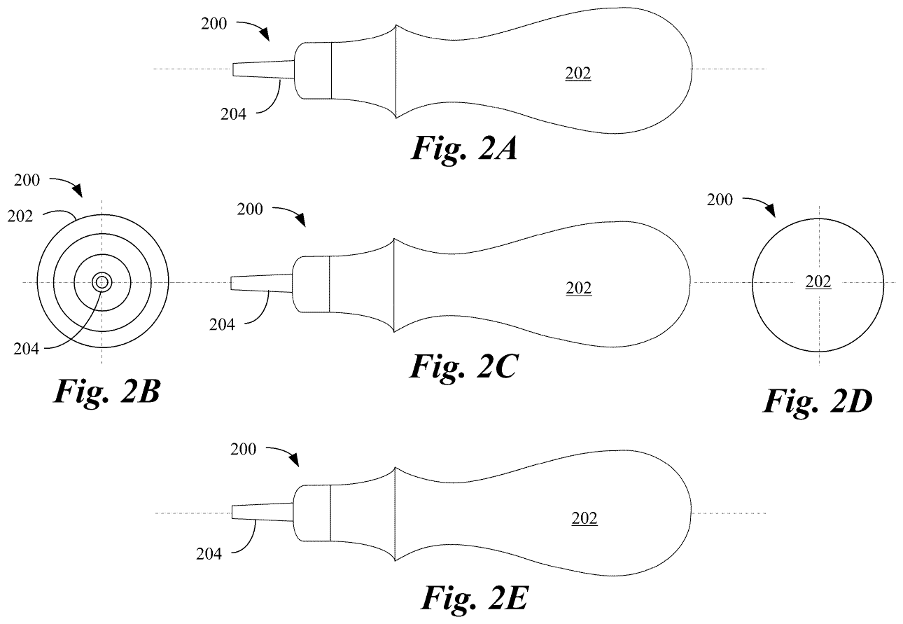

FIG. 2A is a top view of a cutting tool 200 according to the present disclosure. FIG. 2B is a front end view of cutting tool 200. FIG. 2C is a side view of cutting tool 200. FIG. 2D is a back end view of cutting tool 200. FIG. 2E is a bottom view of cutting tool 200. As seen in FIGS. 2A-2E, cutting tool 200 comprises a rounded handle 202 attached to a generally-cylindrical cutter 204 at one end. In the embodiment shown in FIGS. 2A-2E, cutter 204 is hollow and has a slight taper. The leading edge of cutter 204 is sharp, to facilitate cutting of soft materials. The shape and size of cutter 204 is selected to cut an aperture suitable for insertion and retention of a weight, as described in further detail below. In the embodiment shown in FIGS. 2A-2E, the diameter of cutter 204 is approximately ⅛ of an inch.

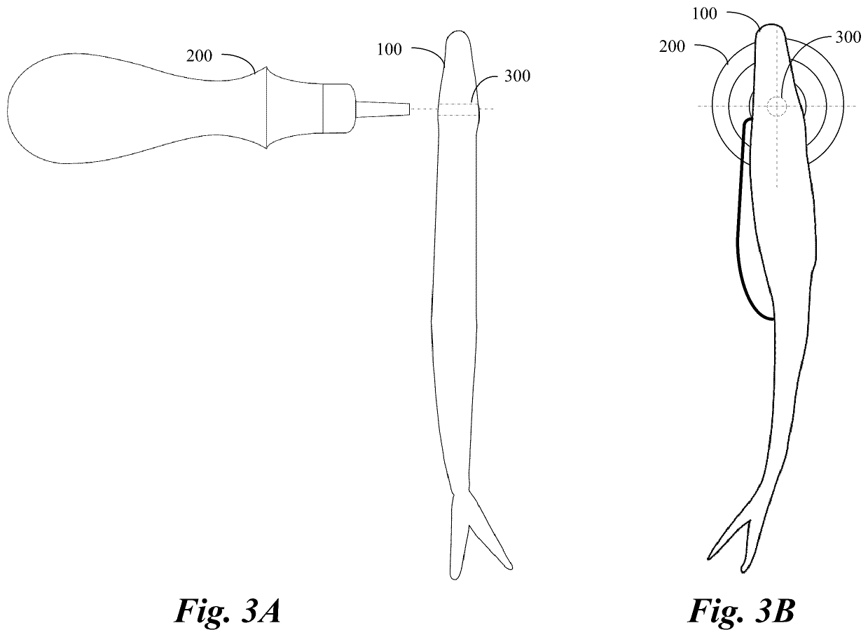

FIG. 3A is a top view of the first stage of a cutting operation according to the present disclosure. FIG. 3B is a side view of the first stage of the cutting operation shown in FIG. 3A. As seen in FIGS. 3A and 3B, cutting tool 200 is oriented generally perpendicularly to the side of fishing lure 100 and aligned to a target cutting area 300. In this embodiment, target area 300 is disposed generally in the center of the head portion of fishing lure 100.

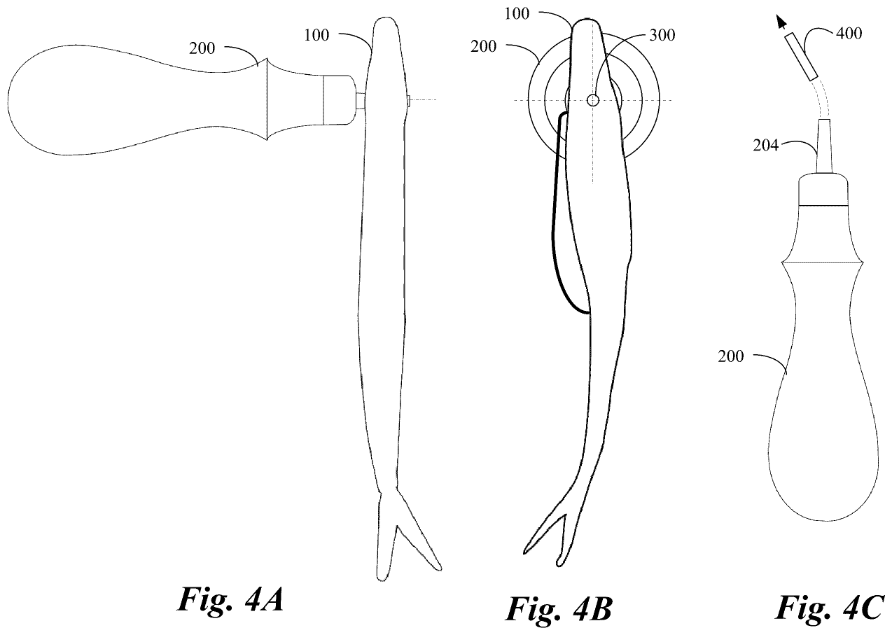

FIG. 4A is a top view of a second stage of the cutting operation shown in FIGS. 3A and 3B. FIG. 4B is a side view of the second stage of the cutting operation. FIG. 4C is a top view of a third stage of the cutting operation. In these figures, cutting tool 200 has been pressed through the side of lure 100 to cut a generally-cylindrical hole therein at target area 300 of fishing lure 100. After the cutting of the generally-cylindrical hole in fishing lure 100, a generally-cylindrical plug 400 remains inside cutter 204. Plug 400 comprises the material removed from target area 300 of fishing lure 100. After the cutting step, plug 400 is removed from cutter 204, as shown in FIG. 4C.

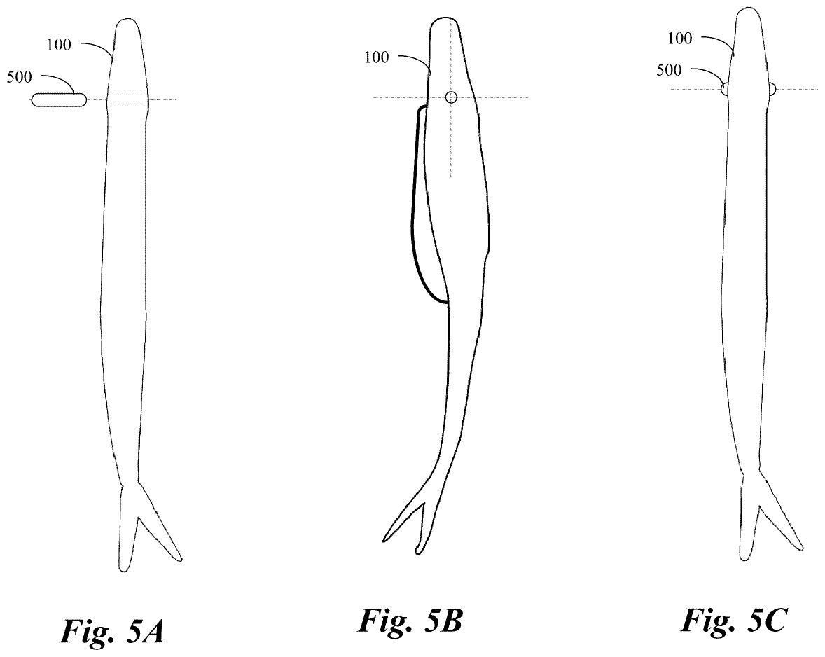

FIG. 5A is a top view of a weight insertion operation. FIG. 5B is a side view of fishing lure 100 having a weight 500 inserted therein. FIG. 5C is a top view of the fishing lure and weight assembly shown in FIG. 5B. Weight 500 is shaped and sized to fit securely within the hole created within fishing lure 100 using cutting tool 100. The mass of weight 500 is selected according to the overall lure behavior desired.

In addition to increasing the mass and balance of fishing lure 100, weight 500 may perform other functions. Weight 500 may include visual characteristics. It may have appropriate colors and patterns. It may have light reflection or light emission characteristics. Weight 500 may also include a scent pod to emit a scent designed to attract fish to lure 100. Weight 500 may also emit a sound designed to attract fish to lure 100. An example of such a device would be a rattle. Other sound-emitting devices may also be suitable.

The foregoing summary, as well as the following detailed description of certain embodiments of the present disclosure, will be better understood when read in conjunction with the appended drawings. For the purpose of illustrating the disclosure, certain embodiments are shown in the drawings and described herein. It should be understood, however, that the present disclosure is not limited to the arrangements and instrumentalities shown in the attached drawings.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refers to at least one of something selected from the group consisting of A, B, C . . . and N, the text should be interpreted as requiring only one element from the group, not A plus N, or B plus N, etc.

1. An improved fishing lure having an elongated flexible body having a rigid hook disposed therein, made by a process comprising the steps of:
cutting a generally-cylindrical aperture through a side of the flexible fishing lure at a target location; and
inserting a generally-cylindrical weight to the generally-cylindrical aperture in the flexible fishing lure.

2. A method of making an improved fishing lure, comprising the steps of:
providing a flexible fishing lure having an elongated flexible body having a rigid hook disposed therein;
cutting a generally-cylindrical aperture through a side of the flexible fishing lure at a target location; and
inserting a generally-cylindrical weight to the generally-cylindrical aperture in the flexible fishing lure.
